(19) United States
(12) Patent Application Publication
(10) Pub. No.: US 2025/0003617 A1
(43) Pub. Date: Jan. 2, 2025

(54) REMOTE REALTIME MONITORING OF AN INDUSTRIAL VENTING SYSTEM

(71) Applicant: OnPoint Industrial Services, LLC, Deer Park, TX (US)

(72) Inventors: Gregory Chad Robl, Deer Park, TX (US); Shawn Wolfe, Deer Park, TX (US); Arturo-Ludek Garcia, Deer Park, TX (US); David Frinsco, Deer Park, TX (US)

(73) Assignee: OnPoint Industrial Services, LLC, Deer Park, TX (US)

(21) Appl. No.: 18/758,274

(22) Filed: Jun. 28, 2024

Related U.S. Application Data
(60) Provisional application No. 63/511,411, filed on Jun. 30, 2023.

(51) Int. Cl. F24F 11/49; F24F 11/00; F24F 11/50; F24F 110/40

(52) U.S. Cl. CPC F24F 11/49; F24F 11/0001; F24F 11/50; F24F 2110/40

(57) ABSTRACT

Information about vent fluid flow through a confined spaces in multiple processing facilities is sensed and transmitted to a remote location. Sensing includes obtaining a pressure differential of vent fluid flow across a filter or at different locations along a length of a flow line. The sensed information is transmitted using wireless communication means. The vent fluid flow sensed at the multiple facilities is monitored at the remote location, and a need for corrective action is determined based on monitoring the flow. Monitoring units are used to transmit the vent fluid flow information, one or more of which are disposed at each processing facility. The monitoring units are transported in a transportation unit, which is equipped to secure multiple monitoring units within and protect the units from damage during transit. When venting at a particular processing facility is completed, the monitoring unit is transported to different processing facility.

This application claims priority to and the benefit of co-pending U.S. Provisional Application Ser. No. 63/511,411, filed Jun. 30, 2023, the full disclosure of which is incorporated by reference herein in its entirety and for all purposes.

### BACKGROUND OF THE INVENTION

### 1. Field of Invention

The present disclosure relates to monitoring industrial venting performance in real time and remotely.

### 2. Description of Prior Art

Industrial facilities used for production and/or processing include equipment that is periodically brought out of service for repair or maintenance. Some of this equipment, such as vessels, reactors, drums, columns, towers, and heat exchangers, have internal confined spaces that are not in communication with ambient surroundings. The equipment is usually vented with a forced vacuum causing ambient air to enter the confined spaced when the repair or maintenance involves personnel accessing inside the confined space(s). Venting fluid flow is sometimes quantified in terms of air changes per hour, which equals the volumetric flow rate of air divided by the confined space volume, safety regulations sometimes dictate the change out values.

In one type of venting, a collector system having a fan or blower draws air from within the confined space through ducting, that sometimes has multiple legs strategically located in the confined space. The air pulled from within the confined space is usually replaced with ambient air drawn into the confined space, usually through a manway or other opening in a side of the equipment. A filter in the collector system upstream of the collector blower captures particulate matter (e.g., dust, catalyst, welding debris, etc.) entrained in the venting fluid exiting the confined space. Currently, venting fluid flowrate through the ducting is measured manually with handheld devices. As inadequate flow of venting fluid can create a hazardous situation inside a confined space, a need exists for continuous monitoring of venting fluid flowrate.

### SUMMARY OF THE INVENTION

Disclosed is an example of a method of venting that includes transporting a ventilation system to where a confined space is located, where the ventilation system includes a line, a filter in the line, and a blower. The method also includes providing communication between the confined space and an upstream end of the line, providing communication between an inlet of the blower and a downstream end of the line, drawing air from within the confined space by activating the blower to create a flow of air through the line, sensing a characteristic of the flow of air within the line, transmitting data representing the characteristic of the flow of air to a monitoring location that is remote from the confined space, and transporting the ventilation system to where another confined space is located and repeating the steps of venting, sensing, and transmitting data. The ventilation system optionally includes a monitoring unit, and the method further involves transporting the monitoring unit inside of a transportation unit, the transportation unit having a joist on which the monitoring unit is supported, and a pivoting plate that is hingedly affixed to the joist; in this example the monitoring unit is part of a unit package and the method further includes securing the monitoring unit within the transportation unit by pivoting the pivoting plate into coupling engagement with a lower surface of the unit package. Further in this optional example, a magnet is on the lower surface of the unit package, and where the pivoting plate is made up of a ferromagnetic material, so that the pivoting plate is coupled with the monitoring unit by a magnetic attraction between the magnet and the ferromagnetic material. In an embodiment, the method further includes monitoring the data at the remote location, and optionally the monitored data is one or both of pressure of air in the line and a flowrate of air in the line. In an alternative, a characteristic of the flow of air is manually sensed within the line. The method optionally includes identifying a blockage of the flow of air to the blower based on the step of manual sensing. Examples of the method include identifying corrective action based on the monitored data, where the corrective action is to change a section of the line, replace a cartridge in the filter, or both. In examples, the data being monitored represents a characteristic of another flow of air in a different line.

Also disclosed is a system for venting, where the system includes a collector blower having a suction and a discharge, a suction line having an end connected to the suction and an opposite end in a confined space, a filter in the suction line, sensor taps in the suction line, a monitoring unit with a transducer in communication with the sensor taps and in wireless communication with a remote location, and a transportation container, which is made up of a horizontal joist that selectively receives a unit package that comprises the monitoring unit, and a member having an edge pinned to the joist and that selectively pivots into coupling engagement with the unit package. In examples, the sensor taps are upstream and downstream of the filter, or are optionally spaced at different locations along a length of the suction line. In one example, the coupling engagement is between a magnet and a ferro-metallic material. In embodiments, the coupling engagement interferes with lateral movement of the monitoring unit inside the transportation unit. Alternatives exist having additional sensor taps in the line that are configured to receive a handheld device. A monitor is optionally included at the remote location that receives the sensed data, which in alternatives receives sensed data from another flow of air in a different line. The system optionally includes another collector blower, another suction line with sensor taps, another filter in the another suction line, another monitoring unit with a transducer in communication with a remote location; and another transportation container.

### BRIEF DESCRIPTION OF DRAWINGS

Some of the features and benefits of the present invention having been stated, others will become apparent as the description proceeds when taken in conjunction with the accompanying drawings, in which:

FIG. 1 is a schematic example of a confined space venting system with remote monitoring.

FIG. 2 is a schematic example of a monitoring unit for use with the system of FIG. 1.

FIG. 3 is a schematic example of multiple confined space venting systems with the same remote monitoring.

FIG. 4 is a perspective view of an example of a monitoring unit package.

FIGS. 5A-5I are perspective views of an example of a transportation unit for transporting the monitoring unit of FIG. 1.

While subject matter is described in connection with embodiments disclosed herein, it will be understood that the scope of the present disclosure is not limited to any particular embodiment. On the contrary, it is intended to cover all alternatives, modifications, and equivalents thereof.

### DETAILED DESCRIPTION OF INVENTION

The method and system of the present disclosure will now be described more fully hereinafter with reference to the accompanying drawings in which embodiments are shown. The method and system of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout. In an embodiment, usage of the term “about” includes +/−5% of a cited magnitude. In an embodiment, the term “substantially” includes +/−5% of a cited magnitude, comparison, or description. In an embodiment, usage of the term “generally” includes +/−10% of a cited magnitude.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation.

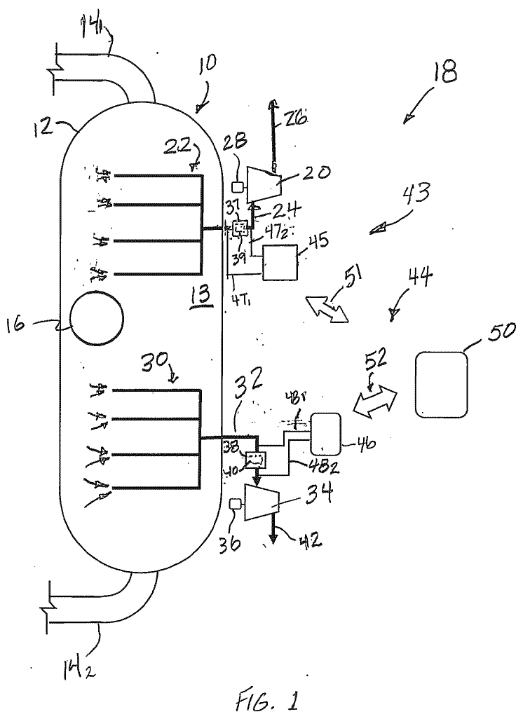

Shown in FIG. 1 is a schematic example of a vessel 10 with walls 12 that define a confined space 13 within vessel 10, where walls 12 include sidewalls that extend along a length of vessel 10, and walls making up the upper and lower head portions of the vessel 10. In this example, the walls 12 define a barrier so that the confined space 13 is substantially out of communication with the ambient environment outside of vessel 10. Shown in this example, included with vessel 10 are inlet and outlet lines 14_{1,2} for a flow of process fluids into and out of vessel 10; and a manway 16 formed through walls 12 that provides access to the combined space 13 within vessel 10.

An example of a ventilation system 18 is shown coupled with vessel 10 for providing ventilation to within confined space 13; such as when the vessel 10 is out of service, and the confined space 13 is being accessed by operations and/or service personnel. Examples of the vessel 10 include a container for handling, processing, or holding an amount of fluid, such as a reactor, a tank, a tower, a regenerator, a heat exchanger, and the like. In the example of FIG. 1, vessel 10 is part of a processing facility in which fluids are refined, produced, and/or processed. Examples of the processing facility include an oil refinery, a facility for processing chemicals, a facility for producing chemicals, and any other facility in which fluids are being handled. In alternatives, the confined space 13 includes any volume confined within a piece of industrial equipment located in a processing facility or an industrial site. In a further example, a confined space is any area obligated to have ventilation; such as but not limited to those identified in OSHA 1926.353, 1910.252, and 1910.146, which are incorporated by reference herein in their entireties and for all purposes. Included with the ventilation system 18 is a collection blower 20 for generating a flow of air through the vessel 10. In the illustrated example collection blower 20 draws ambient air from within confined space 13 into a collection circuit 22, then into a collection inlet line 24 that penetrates walls 12 of vessel 10, and connects to an inlet of collection vent blower 20. Air drawn into collection blower 20 is discharged through a collection discharge line 26 . . . . In this example, collection circuit 22 includes collection leads that are spaced apart and that connect to a header, which provides communication of leads to collection inlet line 24 Ends of the collection leads opposite the header are open to the confined space 13, so that the confined space 13 is in communication with lines 24, 26 and blower 20. Arrows depict collection fluid entering the open ends of the collection leads. Collection blower 20 is shown coupled with a collection motor 28 that is powered by an electrical source (not shown) and for driving blades (not shown) within the collection blower 20.

Vessel 10 of FIG. 1 is shown including another collection circuit 30 having inlet leads with ends open to the confined space 13, and opposite ends connected to a header. Circuit 30 includes an exit line that connects between header and a coupling (not shown) in the walls 12 of vessel 10; coupling connects to an upstream end of a collection inlet line 32, which has an opposite (or downstream) end connected to an inlet of a collection blower 34. As shown, a shaft from a collection blower motor 36 connects to collection blower 34, so that when motor 36 is energized the shaft is rotated for driving blades (not shown) within blower 34, which draws air from within confined space 13 into line 32 and to blower 34. Upstream of collection blowers 20, 34 and within the collection inlet lines 24, 32 are filter assemblies 37, 38 shown having a filter cartridge 39, 40 respectively within for collecting particulate matter that becomes entrained within the vent fluid and is drawn from within confined space 13 by the flow of vent fluid drawn into the confined space 13 from manway 13 and then through collection circuits 22, 30 and collection inlet lines 24, 32. A collection discharge line 42 connects to an outlet of the collection blower 34 and in which the air in circuit 30 is discharged from the collection blower 34 and to ambient.

In the example of FIG. 1, blowers 20, 34 provide a motive force for increasing mechanical energy of vent fluid so that vent fluid is forced through lines 24, 26, 32, 42 and circuits 22, 30, and to remove substances from within confined space 13. In alternatives the substances removed include those deemed hazardous to persons, such as but not limited to particulate matter, fumes, gases, vapors, and the like. In alternatives, vent fluid is provided from a vent fluid source (not shown), such as a vessel or pipeline, and alternatives to blowers 20, 34 include fans, compressors, air pumps, and any other source of energy capable of forcing a designated flow of venting fluid through vessel 10. A designated amount of vent fluid flow through the vessel 10 is determinable by one of ordinary skill in the art. As illustrated, open ends of the discharge leads and collection leads are strategically located within the confined space 13 to direct the flow of venting fluid throughout the confined space 13 so that substantially the entire confined space 13 is safely accessible by operations personnel. In alternatives the leads, headers, and/or lines making up circuits 22, 30 include hard ducting and flexible ducting, where individual ducts are of varying sizes, lengths, and configurations.

Still referring to FIG. 1, included with ventilation system 18 are monitoring systems 43, 44 for monitoring characteristics of the flow of the vent fluid through the vessel 10 and confined space 13. Example characteristics of the flow sensed include pressures of the air in lines 24, 32, flowrates of air in lines 24, 32, and combinations. Monitoring includes ensuring that an adequate amount of vent fluid is flowing throughout the vessel 10 so that the environment within the confined space 13 does not pose a risk for personnel. An example of ensuring that an adequate amount of vent fluid is flowing throughout the vessel 10 includes sensing the flowrates of vent fluid flowing through lines 24, 32 and comparing the sensed flowrates with a designated flowrate that is adequate for satisfying an air change out requirement. Included with the monitoring systems 43, 44 of FIG. 1 are monitoring units 45, 46 that are in communication with vent fluid flowing through collection inlet line 24 via lines 47_{1,2} and collection inlet line 32 via lines 48_{1,2}. As shown, lines 47_{1,2}, 48_{1,2} connect to lines 24, 32 at points upstream and downstream of the filter assembly 37, 38. In a non-limiting example of use, pressure upstream and downstream of filter assemblies 37, 38 is communicated to monitoring units 45, 46 via lines 47_{1,2}, 48_{1,2} the pressures in lines 47_{1,2}, 48_{1,2} are sensed by transducers (not shown) within monitoring units 45, 46 and converted into data signals that are representative of the pressures sensed within lines 47_{1,2}, 48_{1,2}. In alternatives, flowrates of vent fluid inside lines 24, 32 is estimated based on pressures sensed within lines 47_{1,2}, 48_{1,2}. Human readable values of those pressures are displayable on a console 50, which in this example is remote from the vessel 10 and in communication with the monitoring units 45, 46 via communication means 51, 52. In examples, communication means 51, 52 include its hardwire and wireless, such as radio and/or cellular communication protocol.

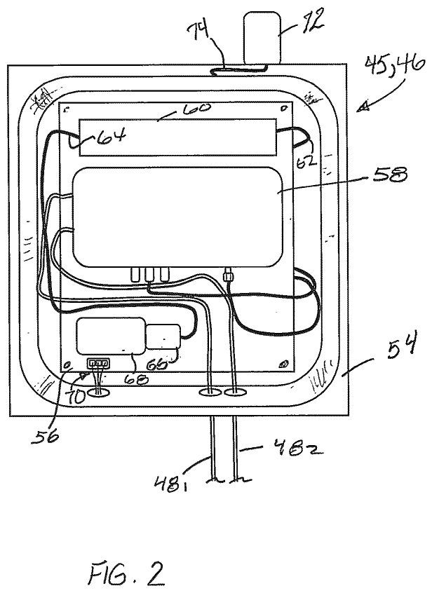

An example of the monitoring units 45, 46 is shown schematically in FIG. 2. Monitoring units 45, 46 include an outer housing 54 and board 56. Housing 54 has a generally rectangular configuration, and board 56 is shown as a planar member mounted on a rear vertical wall of housing 54. On board 56 is a monitoring module 58, which in alternatives includes the transducer for converting the sensed pressure into data signals. An inverter 60 is shown mounted onto board 56 and which via lines 62, 64 receives electricity in an alternating current and converts it to a direct current for delivery to and for powering monitoring module 58. An end of line 64 distal from inverter connects to a connector 66 which mounts onto a surge protector 68. An end of surge protector 68 opposite connector 66 is in communication with electricity from a local source (not shown). A terminal block 70 is included on the board 56 adjacent surge protector 68, wires extending from terminal block 70 pass through an opening in housing 54. In an example, ends of wires opposite terminal block 70 connect within a junction box (not shown) that receives electricity from the same source (not shown) that feeds motor 36 (FIG. 1) after being stepped down in voltage. Electricity flowing through wires and to terminal block 70 provides a source of electricity for powering electrical components within monitoring unit 46; such as through receptacles (not shown) within housing 54 to which surge protector 68 is connected. The wires connecting to the terminal block 70 include a neutral, a hot, and a ground wire, which extend from a three-prong plug that inserts into the terminal block. From the terminal block, the wires connect to a pair of three-prong outlets. The surge protector is then connected to this outlet. An antenna 72 is included with unit 46 that connects to an output of a transmitter within monitoring module 58 via line 74. Further shown is that lines 48_{1,2} enter through a sidewall of housing 54 and connect to ports on a side of monitoring module 58.

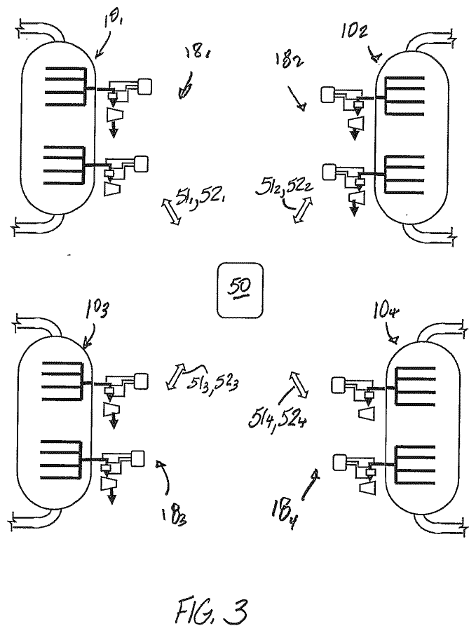

An alternative example of monitoring is illustrated in FIG. 3, which depicts multiple vessels 10₁₋₄ each with a ventilation system 18₁₋₄ that are in communication with the console 50 via separate communication means 51₁₋₄, 52₁₋₄. In the example of FIG. 3, the separate vessels 10₁₋₄ are alternatively in the same process facility, or in different process facilities and located remotely from one another and remote from console 50. An advantage of this example is the ability to monitor multiple ventilation systems 18₁₋₄ by a single location that is optionally remote from either one or more of the systems 18₁₋₄. The monitoring system 44 of the present disclosure is not limited to the number of vessels 10, 10₁₋₄ or ventilation systems 18, 18₁₋₄ shown in FIG. 1 or 3, but instead is applicable for use with any number of vessels and/or ventilation systems.

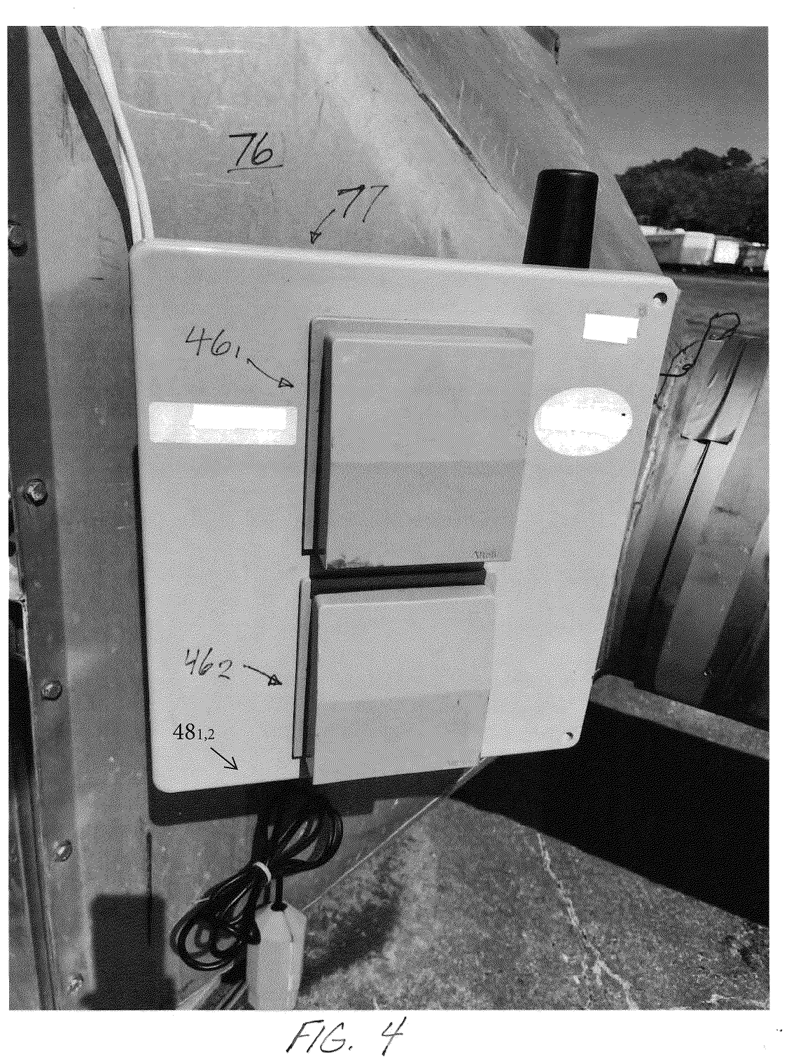

Referring now to FIG. 4, shown in a perspective view is a pair of monitoring units 46_{1,2} mounted onto a board that is coupled to a piece of industrial equipment 76. In examples, the equipment 76 is a vent fan such as a blower 20 and/or collection blower 34 of FIG. 1. Included in FIG. 4 is an example of a monitoring unit package 77, which is formed by combining the monitoring units 46_{1,2} on a board having coupling elements (not shown), and removably mounted to the piece of industrial equipment 76. In the example of FIG. 4, the monitoring units 46_{1,2} are included with a single ventilation system 18 (FIG. 1), alternatives include the monitoring units 46_{1,2} being included with more than one ventilation system, and there being one or more than two monitoring units 46_{1,2}.

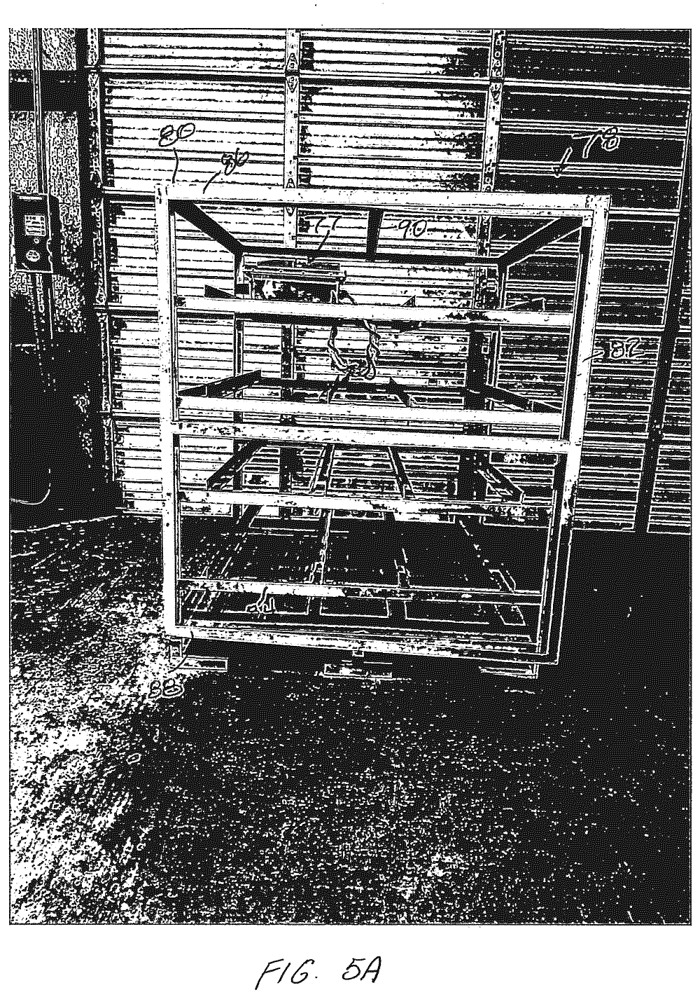

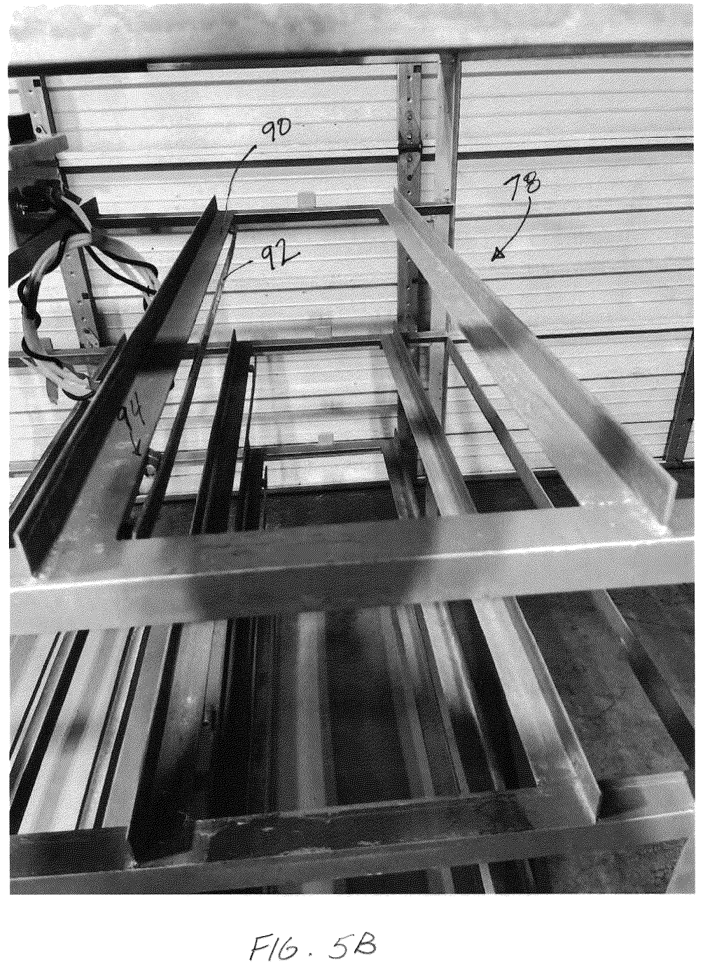

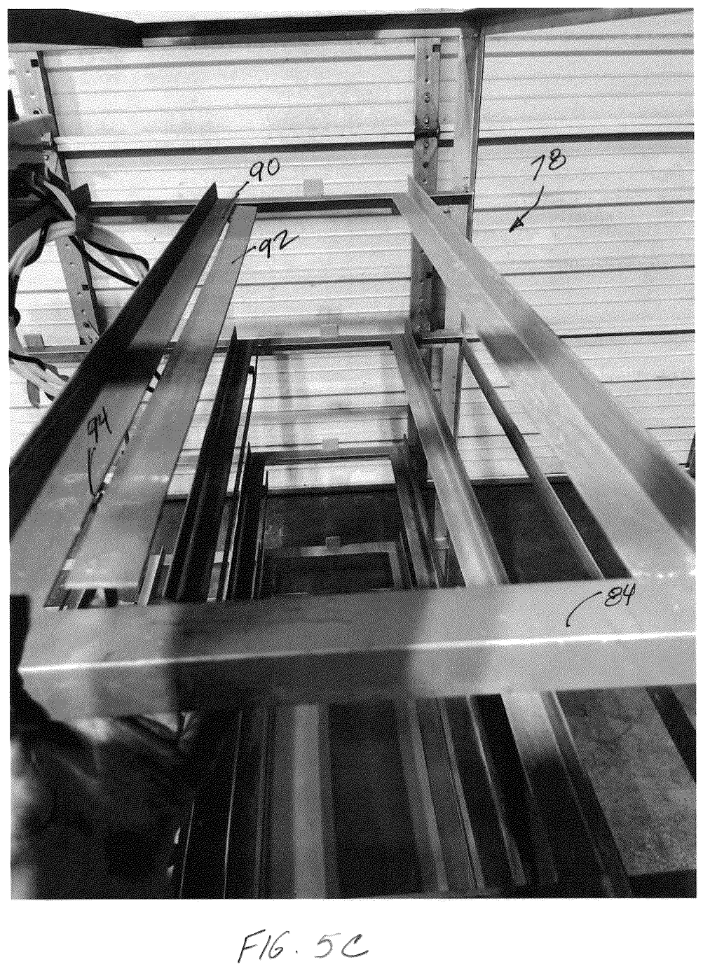

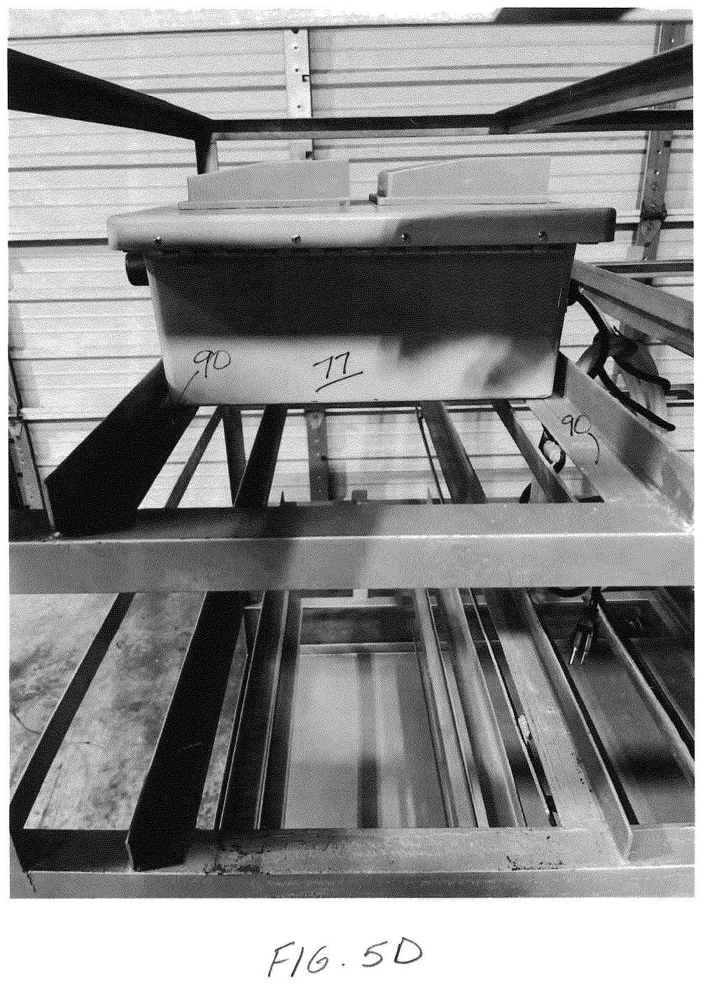

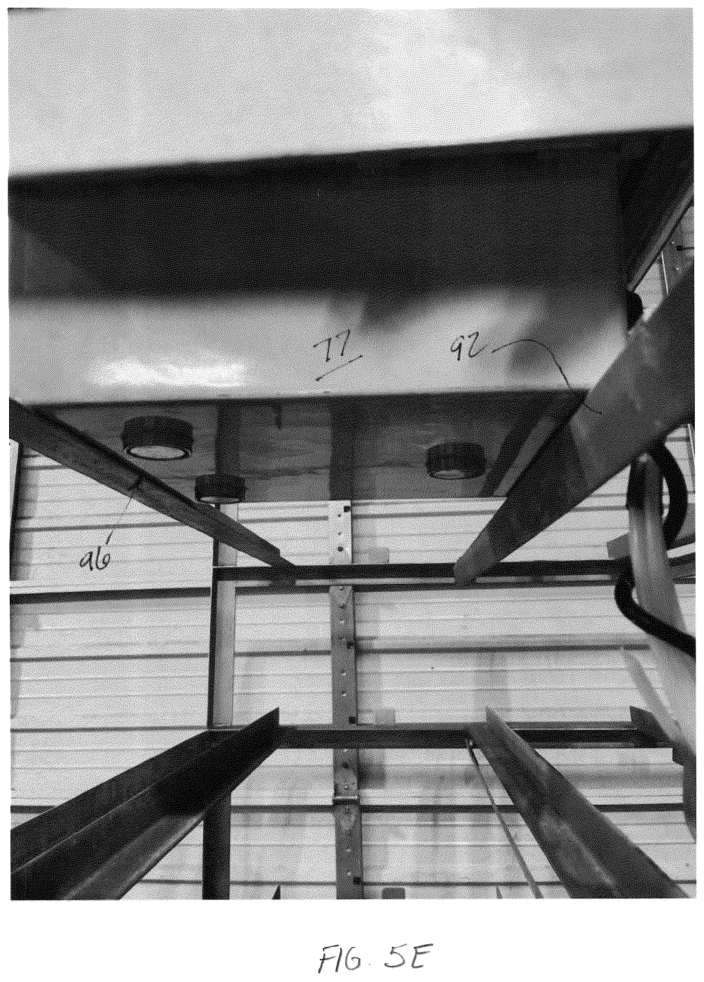

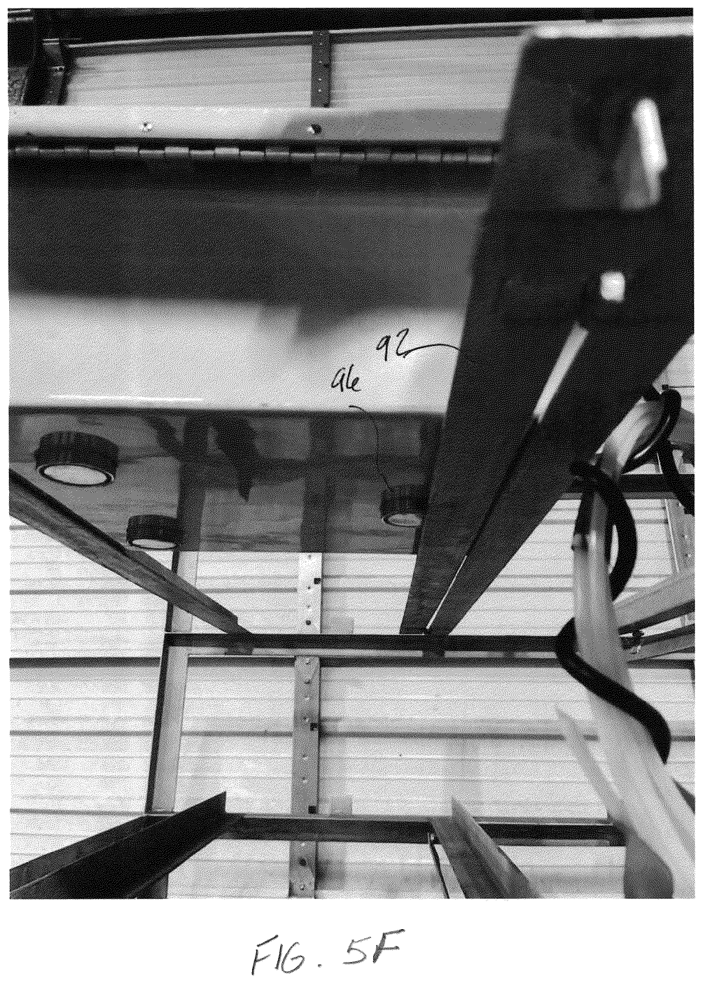

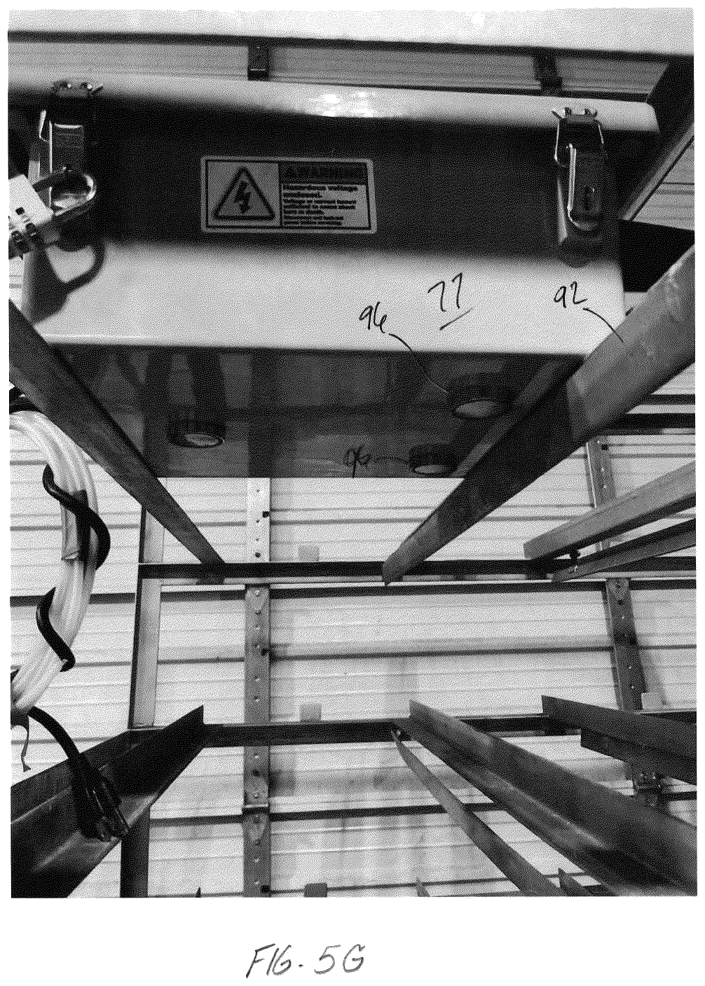

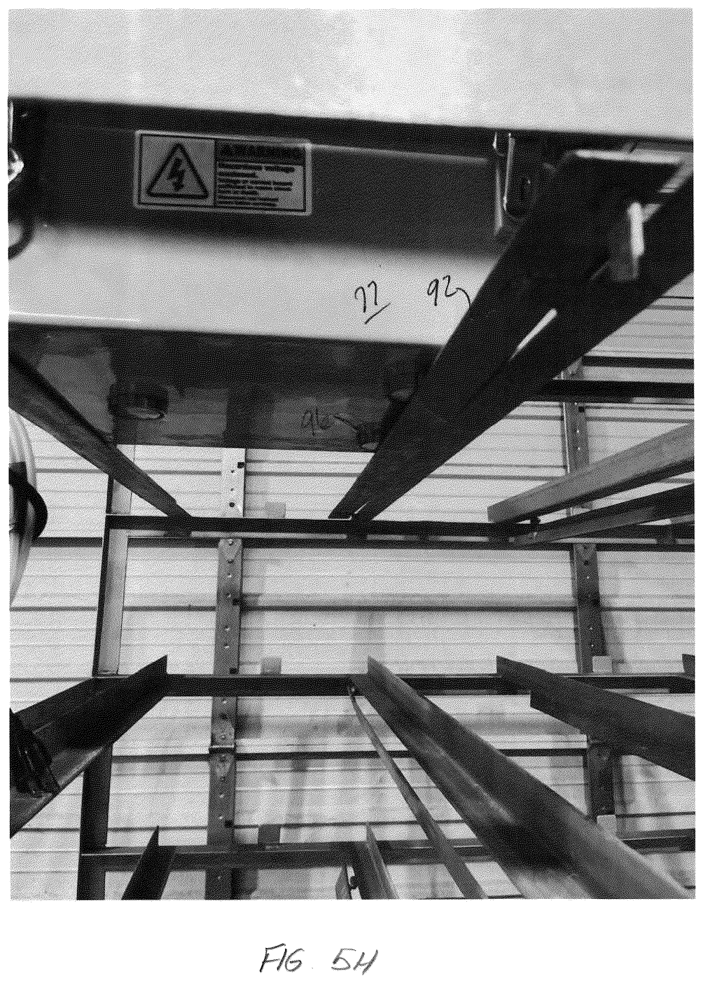

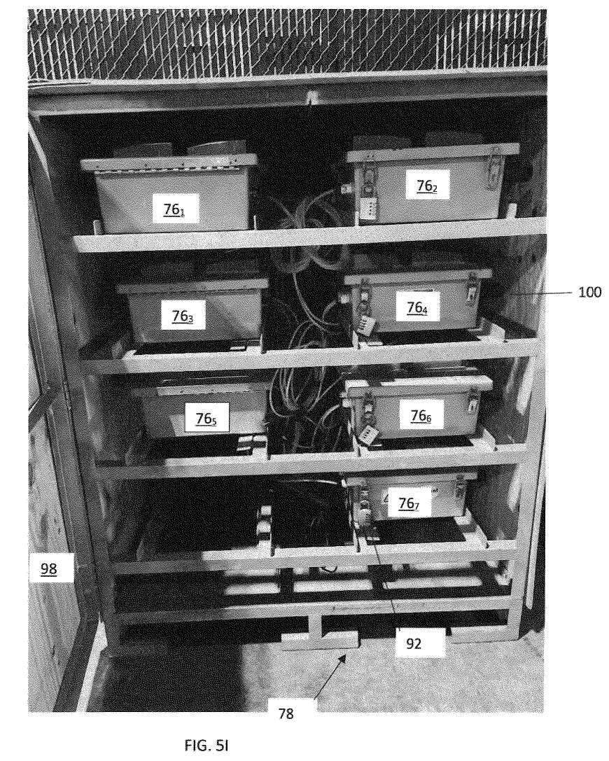

Shown in perspective views in FIGS. 5A through 5I are examples of a transportation unit 78 for safely transporting one or more monitoring units 46 (FIG. 2). Referring to FIG. 5A, transportation unit 78 is shown having a frame 80 made up of elongate vertical studs 82 on its corners. Along forward and rearward ends of the frame 80 are girts 84, which are elongate members spanning horizontally between and connected to vertical studs 82 on opposing lateral sides of the frame 80. Elongate upper and lower plates 86, 88 are on the forward and rearward ends of the frame 80, where upper plates 86 extend between and connect to upper ends of studs 82 on opposing lateral sides of the frame 80, and lower plates 88 extend between and connect to lower ends of those vertical studs 82. A series of joists 90 are shown with opposing ends connecting to forward and rearward girts 84 of frame 80. In examples shown, joists 90 are elongate members formed with 90 degree angle iron.

Referring now to FIGS. 5B and 5C a pivoting plate 92 is shown mounted to a lateral side of one of the joists 90 by hinges 94. Plate 92 is a planar elongate member having a length that extends substantially parallel with and along a length of the joist 90. The hinges 94 as shown each include annular barrels connected either to one of the joists 90 or plate 92; axial bores are formed through each of the barrels and shown registered with one another. The barrels are coupled together by a hinge pin shown extending through them, the hinge pin maintains the barrels in axial alignment while allowing them to rotate relative with one another. Attachment of one of the barrels to plate 92 and the other to the joist 90 allows pivoting of the plate 92 with respect to joists 90, where the pivoting is about their respective edges adjacent one another and which extend along their elongate lengths. In the example of FIG. 5B, plate 92 is in a plane generally oblique with a plane in which joist 90 is disposed. In FIG. 5C the plate 92 is pivoted from its orientation in FIG. 5B into a plane that is generally parallel with a plane of the joist 90. For the purposes of discussion herein, the plate 92 is shown in a disengaged orientation in FIG. 5B and in an engaged orientation in FIG. 5C. In FIGS. 5D and 5E an example of a monitoring unit package 77 is shown resting on a pair of adjacent joists 90. The joists 90 of FIGS. 5D and 5E provide elevational support to the monitoring unit package 77 by exerting a force onto the monitoring unit package 77 that counters, or is in a direction opposite to, a gravitational force applied to the monitoring unit package 77. The elevational support is applied by horizontal portions of the joists 90 both when the plate 92 is in either the oblique orientation shown in FIG. 5E and also when the plate 92 pivoted up into the horizontal position as shown in FIG. 5F. In the examples of FIGS. 5E and 5F, a lower surface of the unit package 77 is shown having magnets 96 mounted thereon. Magnets 96 are disposed at strategic locations, so that when the plate 92 is pivoted into the horizontal position (i.e., the engaged orientation) the plates 92 become magnetically coupled with magnets 96. The coupling between the unit package 77 and plate 92 includes a force that impedes horizontal or lateral movement of the unit package 77. Pivoting the plate 92 from the disengaged to the engaged orientation easily and readily secures the unit package 77 to the joist 90 (via the hinge 94 coupling the joist 90 and plate 92). As the joist 90 is substantially rigidly connected to the frame 80, unit package 77 is restrained from movement within the transportation unit 78.

Further examples of how pivoting the plate 92 with respect to joist 90 provides securement between plate 92 and unit package 77 are provided in FIGS. 5G and 5H. In the example of FIG. 5I, a number of units 77₁₋₆ are shown within the transportation unit 78 and the unit 78 is equipped with a door 98 for an additional measure of retaining the units 77₁₋₆ within the transportation unit 78. Further, sidewalls 100 are provided along the lateral and rear surfaces of the transportation unit 78 for providing an enclosure to prevent mechanical damage to the unit packages 77₁₋₆ as well as protection from environmental hazards.

In a nonlimiting example of operation, a ventilation system 18 (FIG. 1) is installed onto a piece of industrial equipment and for venting a confined space 13 within the equipment. One or more blowers 20, 34 are energized for creating a flow of vent fluid through the confined space 13. A handheld device (not shown) is taken by operations personnel and flow(s) of vent fluid into each of the pipes making up the collection circuit 30 are measured. Additional manual handheld measurements of vent fluid flow are obtained at discharge lines 26, 42. By recording these values, a baseline vent fluid flow is obtained. For a period of time while the equipment or vessel 10 is out of commission and being serviced or repaired and the vent fluid is being circulated through the confined space 13, information about the vent flow is recorded by the monitoring unit 46 and transmitted to the console 50 via communication means 52. Based on information received at the console 50, a need for corrective action of the ventilation system 18 is identified. Further examples of a console 50 include systems in a control room at the remote location with control screens and/or monitors that are visually monitored by personnel and which will determine corrective action is required within the ventilation system 18, or one of the ventilation systems 18₁₋₄ (FIG. 3) when monitoring multiple vent systems. The present disclosure includes embodiments in which the steps of monitoring, determining corrective action, and undertaking corrective action, are all automated. Some embodiments include a combination of automated and manual actions, such as when a flowrate and/or pressure being monitoring unit 46 has dropped to at or below a designated value, a flowrate and/or pressure in line 32 (upstream and/or downstream of filter 38) is measured by the handheld device to identify a cause of the drop in flowrate and/or pressure. In examples in which the drop is due to a restriction in line 32 or filter 38, a location of the restriction is determinable based on the measurements taken with the handheld device. Examples of corrective action include replacing the cartridge 40 (when the restriction is found in the filter 38), or replacing all or a portion of line 32 (when the restriction is found in the line 32). In one alternative, a pressure drop of vent fluid flowing across filter 38 is being monitored, and when it is observed that the monitored pressure drop exceeds a designated pressure drop, a decision is made to replace the filter cartridge 40. Optionally, such as in embodiments without a filter in line 32, flow information is obtained by monitoring pressure in lines 48_{1,2} that connect to taps located at spaced apart location along a length of line 32. In addition to changing the filter cartridge 40 or line 32, other corrective action incudes configuring (or reconfiguring) the shape or location of the circuits 22, 30 or confirming vent fluid flow is adequate through circuits 22, 30. In examples, information about different ventilation systems 18 at varying geographical locations is simultaneously transmitted to the console 50, which is remote from one or all of the ventilation systems 18 and which is monitored in a real time environment. Real time and remote monitoring provides a significant advantage in scenarios when substances within the confined space 13 render it potentially hazardous for personnel to safely enter and/or conduct operations in the confined space 13. When a particular operation is completed at a specific operating facility having the confined space 13 and venting is no longer needed, the ventilation system 18 is then deactivated, disconnected from the vessel 10, and moved and connected to a separate vessel, such as one of vessels 10₁₋₄, which in examples is in the same process facility or a different process facility that is also remote from the console 50, and then reconnected with the console 50 for remote monitoring of the ventilation system 18. Further in this example, the use of transportation unit 78 provides an advantage of safe and reliable transportation of the monitoring unit packages 77 (and monitoring units 46_{1,2} of packages 77) between the different locations, as the unit packages 77 are secured within the transportation unit 78 and prevented from potentially damaging movement within.

Console 50 (FIG. 1) optionally includes a processor and a non-transitory computer-readable memory accessible by the processor and having executable code stored thereon. The executable code includes a set of instructions that causes a processor to perform operations that include obtaining characteristics of the flow of air in line 32 based on the sensed data received from monitoring unit 46. In alternatives, the instructions of executable code are stored in memory of a processing system, or on computer diskette, magnetic tape, conventional hard disk drive, electronic read-only memory, optical storage device, a data storage device such as server as a non-transitory computer readable storage medium or other appropriate data storage device having a non-transitory computer readable storage medium stored thereon.

The present invention described herein, therefore, is well adapted to carry out the objects and attain the ends and advantages mentioned, as well as others inherent therein. While a presently preferred embodiment of the invention has been given for purposes of disclosure, numerous changes exist in the details of procedures for accomplishing the desired results. These and other similar modifications will readily suggest themselves to those skilled in the art, and are intended to be encompassed within the spirit of the present invention disclosed herein and the scope of the appended claims.

What is claimed is:

1. A method of venting comprising:
a. transporting a ventilation system to where a confined space is located, the ventilation system comprising a line, a filter in the line, and a blower;
b. providing communication between the confined space and an upstream end of the line;
c. providing communication between an inlet of the blower and a downstream end of the line;
d. drawing air from within the confined space by activating the blower to create a flow of air through the line;
e. sensing a characteristic of the flow of air within the line;
f. transmitting data representing the characteristic of the flow of air to a monitoring location that is remote from the confined space; and
g. transporting the ventilation system to where another confined space is located and repeating steps (b)-(f).

2. The method of claim 1, wherein the ventilation system further comprises a monitoring unit, the method further comprising transporting the monitoring unit inside of a transportation unit, the transportation unit comprising a joist on which the monitoring unit is supported, and a pivoting plate that is hingedly affixed to the joist.

3. The method of claim 2, wherein the monitoring unit is part of a unit package, the method further comprising securing the monitoring unit within the transportation unit by pivoting the pivoting plate into coupling engagement with a lower surface of the unit package.

4. The method of claim 3, wherein a magnet is on the lower surface of the unit package, and wherein the pivoting plate comprises a ferromagnetic material, so that the pivoting plate is coupled with the monitoring unit by a magnetic attraction between the magnet and the ferromagnetic material.

5. The method of claim 1, further comprising monitoring the data at the remote location.

6. The method of claim 5, wherein the monitored data comprises pressure of air in the line and a flowrate of air in the line.

7. The method of claim 5, further comprising manually sensing a characteristic of the flow of air within the line.

8. The method of claim 7, further comprising identifying a blockage of the flow of air to the blower based on the step of manual sensing.

9. The method of claim 5, further comprising identifying corrective action based on the monitored data, wherein the corrective action is selected from the group consisting of changing a section of the line, replacing a cartridge in the filter, and combinations thereof.

10. The method of claim 5, further comprising monitoring data representing a characteristic of another flow of air in a different line.

11. A system for venting comprising:
a collector blower having a suction and a discharge;
a suction line having an end connected to the suction and an opposite end in a confined space;
a filter in the suction line;
sensor taps in the suction line;
a monitoring unit with a transducer in communication with the sensor taps and in wireless communication with a remote location; and
a transportation container comprising,
a horizontal joist that selectively receives a unit package that comprises the monitoring unit, and
a member having an edge pinned to the joist and that selectively pivots into coupling engagement with the unit package.

12. The system of claim 11, wherein the sensor taps are upstream and downstream of the filter.

13. The system of claim 11, wherein the sensor taps are spaced at different locations along a length of the suction line.

14. The system of claim 11, wherein coupling engagement is between a magnet and a ferro-metallic material.

15. The system of claim 11, wherein the coupling engagement interferes with lateral movement of the monitoring unit inside the transportation unit.

16. The system of claim 11, further comprising additional sensor taps in the line that are configured to receive a handheld device.

17. The system of claim 11, further comprising a monitor at the remote location that receives the sensed data.

18. The system of claim 17, wherein the monitor receives sensed data from another flow of air in a different line.

19. The system of claim 11, further comprising another collector blower, another suction line with sensor taps, another filter in the another suction line, another monitoring unit with a transducer in communication with a remote location; and another transportation container.
